(19) United States
(12) Patent Application Publication
(10) Pub. No.: US 2026/0366706 A1
(43) Pub. Date: Nov. 19, 2026

(54) BUTTON BATTERY COMPARTMENT ASSEMBLY AND A CANDLE-LIKE LAMP

(71) Applicant: Xiamen Global Selection Imp & Exp Co Ltd, Xiamen City (CN)

(72) Inventors: Kaiqin HUANG, Xiamen City (CN); Liangliang LI, Xiamen City (CN)

(21) Appl. No.: 19/243,972

(22) Filed: Jun. 20, 2025

(30) Foreign Application Priority Data
May 13, 2025 (CN) 202520937662.5

(51) Int. Cl. F21V 17/16; F21S 6/00; F21S 9/02; F21V 15/01; F21V 17/14; F21V 23/04; F21V 23/06; F21Y 115/10

(52) U.S. Cl. CPC F21V 17/164; F21S 6/001; F21S 9/02; F21V 15/01; F21V 17/14; F21V 17/168; F21V 23/04; F21V 23/06; F21Y 2115/10

(57) ABSTRACT

The application proposes a button battery compartment assembly and a candle-like lamp, including a base and a battery cover. The base is provided with a battery compartment for accommodating a battery. The battery compartment is provided with a guiding groove. The battery cover is able to be switched between a locking position and an unlocking position through the guiding groove, and a portion of the battery compartment other than the guiding groove is provided with an elastic button for unlocking the battery cover. The assembly of the button battery compartment in this application requires a collaborative operation of both hands and is equipped with a secondary locking mechanism, which can ensure the reliable locking of the battery compartment and prevent children from accidentally opening it.

### CROSS REFERENCE OF RELATED APPLICATION

This application claims priority of Chinese patent application number 202520937662.5, filed on May 13, 2025, the entirety of which is incorporated by reference.

### TECHNICAL FIELD

The application belongs to the technical field of LED lamp, in particular to a button battery compartment assembly and a candle-like lamp.

### BACKGROUND

Traditional candles, as a time-honored lighting and decorative tool, have an irreplaceable sense of ceremony and aesthetic value in various life scenarios. However, their reliance on open flame combustion leads to significant safety hazards, comprising fire risks, high-temperature scalding, and combustion gas emissions, and existing usage restrictions when used in confined spaces or children's activity areas. In addition, Traditional candles have inherent defects such as short burning time, frequent replacement, and environment pollution caused by dripping wax.

In order to replace flame candles, LED candle light arises at the historic moment, in the existing technology, LED candle light is usually provided with one or more cover LED light source with diffusion shell to simulate the flame effect, and achieves a wireless/wired application through a built-in battery or an external power supply.

In the design of the battery power supply system of LED simulated candle-like lamps, the battery compartment serves as the core component of the portable lighting device, and the reliability of the switch assembly is directly related to the product safety and the user experience, the existing LED simulated candle-like lamp generally locks/opens battery compartments by ways of using threaded screw caps, push-pull slide rail or auxiliary tool way. Conventional LED simulated candle-like lamps are powered by button batteries and are turned on by manually rotating the battery cover. This assembly has no secondary locking mechanism, which may cause the battery cover to unscrew due to inertia when the device is shaken. Moreover, the opening torque of the battery cover in this way is relatively low, which is below the threshold of a child's finger torque and can be unscrewed by hands. It poses a risk of accidental swallowing of the button battery and exposure of the electrode.

Therefore, this application is intended to propose a button battery assembly and candle-like lamp, which need a collaborative operation by hands and have a secondary locking mechanism.

### SUMMARY

Aiming at the technical problems existing in the prior art, the application provides a button battery compartment assembly and a candle-like lamp.

According to the first aspect of the application, a button battery compartment assembly is provided, comprising a base and a battery cover, the base is provided with a battery compartment for accommodating a battery, the battery compartment is provided with a guiding groove, the battery cover is configured to be switched between a locking position and an unlocking position through the guiding groove, and a portion of the battery compartment other than the guiding groove is provided with an elastic button for unlocking the battery cover.

By adopting the technical solution above, when the battery is imbedded in the battery compartment, the battery cover is pushed along the unlocking position of the guiding groove to the locking position for locking. When it is necessary to unlock the battery cover, the user needs to press the elastic button with one hand to release the lock of the battery cover, and to push the battery cover to rotate along the guiding groove in the unlocking direction with the other hand at the same time to achieve a function of unlocking the battery cover with both hands in coordination. It can effectively prevent the safety hazards of accidentally opening the battery cover caused by children.

In some embodiments, the base is provided with a locking opening in a position corresponding to the elastic button, an edge of the battery cover is provided with a locking arm, and an end of the locking arm is clipped into the locking opening at the locking position.

By adopting the technical solution above, the locking arms can slide along the guiding groove between the locking position and the unlocking position. When the locking arms move to the locking position, its end is clipped into the locking opening to complete the locking. When unlocking is needed, the user presses the elastic button with one hand, and the elastic button pushes the first locking arm out of the locking opening, while the other hand pushes the battery cover in the unlocking direction to complete the unlocking operation.

In some embodiments, a bottom surface of the battery cover is also provided with a force application unit for driving rotation of the battery cover, and the force application unit is located on a side of the bottom surface away from the locking opening.

By adopting the technical solution above, the elastic button and the force application unit form a left-right opposite assembly at the bottom of the battery compartment. When unlocking is needed, the user presses the elastic button with the left hand and pushes the force application unit in the unlocking direction with the right hand. The battery cover can be unlocked only when the actions of the left and right hands are carried out simultaneously.

In some embodiments, the battery cover comprises two locking arms composed of a first locking arm and a second locking arm symmetrically provided on both sides of the battery cover.

By adopting the technical solution above, the force on the first locking arm and the second locking arm is more balanced when they move in the corresponding guiding grooves. The lengths of the first locking arm and the second locking arm are not equal. When there is a length difference between the first locking arm and the second locking arm, they can cooperate with the corresponding guiding grooves to form an installation assembly having a guiding function, which can prevent a misalignment problem caused by the mismatch between the locking arms and the guiding grooves during the installation process for users.

In some embodiments, the first locking arm and the second locking arm are configured to respectively slide from the unlocking position to the locking position, so as to make the end of the first locking arm to be clipped into the locking opening to lock the battery cover; a direction of elastic deformation of the elastic button generated by being pressed is orthogonal to a rotation direction of the force application unit generated by being driven.

By adopting the technical solution above, the setting of the locking opening of the first guiding groove at the locking position and the elastic button constitute a secondary locking mechanism. It is necessary to operate the elastic button with both hands and push the force application unit to unlock, which significantly improves the effect of preventing accidental opening.

In some embodiments, the battery cover is provided with perforated grooves on both sides of the first locking arm, and an end of the first locking arm protrudes to form a clamping part configured to fit with the locking opening, and a thickness of the clamping part gradually decreases along an extension direction of the guiding groove.

By adopting the technical solution above, the arrangement of the perforated groove creates a certain gap between the two sides of the first locking arm and the battery cover, and only one end of the first locking arm is connected to the battery cover to form a cantilever assembly, which enables the first locking arm to have a certain elastic deformation capacity. The shape and size of the clamping part make it similar to a right-angle protrusion having an inclined plane. This makes it easier for the first locking arm to slide along the guiding groove to the locking position, the first locking arm naturally spring up due to the elastic force, and the clamping part is clipped into the locking opening at the same time. It is also more convenient to unlock the clamping part with the elastic button.

In some embodiments, an inner surface of one side of the locking opening is connected to one end of the elastic button, and the elastic button forms an inclined triangular protrusion outside the locking opening, an inclined surface of the elastic button extends downwards towards an edge of the base.

By adopting the technical solution above, the elastic button also has a cantilever assembly similar to the first locking arm, which is more convenient for the user to press it to cause the elastic deformation, so as to be configured to press against the clamping part and push it out of the locking opening, disengaging the first locking arm from the locking opening. The inclined protrusion assembly of the elastic button is more convenient for the user's fingers to press the elastic button from the outside of the base, which is more in line with operating habits.

In some embodiments, the battery compartment is provided with two guiding grooves composed of a first guiding groove and a second guiding groove corresponding to the first locking arm and the second locking arm respectively, the guiding grooves extend circumferentially from the unlocking position to the locking position and gradually approach an inner top surface of the battery compartment, and the locking opening is located at the locking position of the first guiding groove.

By adopting the technical solution above, it is ensured that the sliding strokes of the first guiding groove and the second guiding groove are the same, and the first guiding groove and the second guiding groove gradually approach the inner top surface of the battery compartment along the unlocking position to the locking position. To make the first guiding groove and the second guiding groove have a stepped undulating assembly, during the locking process, and a portion of the battery cover that cooperates with the first and second guiding grooves will be compressed and deformed, thereby having a certain anti-disconnection effect due to compression.

In some embodiments, a bottom surface of the base has at least two columnar legs protruding outwards from the base, and terminal surfaces of the columnar legs and a vertex of the elastic button lie in a common virtual plane.

By adopting the technical solution above, the vertices of the columnar legs and elastic buttons can provide a multi-point support to the base, ensuring stable support for the base while avoiding complete contact between the bottom surface of the base and the placed plane, thus preventing wear of important components such as battery covers due to long-term contact.

In some embodiments, a top surface of the battery cover is provided with a raised clamping component, the clamping component comprises a clamping ring and a clamping column located at the center of the clamping ring, the clamping ring is centered on a center of the top surface of the battery cover.

By adopting the technical solution above, when the battery cover and the battery compartment are locked, the clamping ring and the clamping column can provide stable support for the bottom surface of the battery, press the battery against the battery compartment stably and effectively combined with the assembly that the first and second guiding grooves gradually approaching the top surface inside the battery compartment, and avoid displacement or poor contact of the battery due to shaking or vibration.

According to the second aspect of the application, the application provides a candle-like lamp, comprising a button battery compartment assembly as any one of the above described, further comprising a shell, a switch and a lamp bead, the shell is sleeved over the base, the lamp bead has a first pin and a second pin, and the first pin passes through a top of the battery compartment and is connected with the battery, the base is provided with a switch window on one side of the battery compartment, and the switch is slidably mounted above the switch window, one side of the battery compartment close to the switch window is provided with a connection opening, the first pin passes through a top of the switch and enters the connection opening, the switch drives the second pin to connect with or separate from one side of the battery.

By adopting the technical solution above, the first and second pins of the lamp beads enter from the top and side of the battery compartment respectively and are connected with the top and side of the battery respectively. The user uses the slidable switch to drive the second pin to connect or disconnect with the side of the battery, achieving the function of controlling the on-off of the circuit. The installation of the lamp beads, circuit connection and switch control are integrated in a compact space. While ensuring the electrical conductivity, it also improves the fit accuracy and usage stability of the candle-like lamp.

Compared with the existing technology, the beneficial effects of the application are that:

The button battery assembly and the candle light proposed by the application, effectively solve the problems in the existing technology, such as unreliable battery locking, wrong to open by children easily, the insufficient stability of circuit connection. In the assembly of the button battery compartment, the base and the battery cover form a sliding and rotating connection through the first guiding groove and the second guiding groove in coordination with the first locking arm and the second locking arm. The setting of the locking opening of the first guiding groove at the locking position and the elastic button constitute a secondary locking mechanism. It is necessary to operate the elastic button with both hands and push the force application unit to unlock, which significantly improves the effect of preventing accidental opening. The cantilever elastic assembly formed by perforated grooves on both sides of the first locking arm is fitted with the clamping part to bounce into the locking opening naturally during locking. The locking arms and positioning notches with corresponding sizes form an installation assembly having guidance ability to avoid misalignment and ensure the reliability of locking.

### BRIEF DESCRIPTION OF THE DRAWINGS

Comprising accompanying drawings to provide a further understanding of the embodiments and the drawings are incorporated into this specification and form part of this specification. The drawings illustrate the embodiments and are used in conjunction with the description to explain the principles of the present disclosure. Many expected advantages of other embodiments and embodiments will be easily understood because they are better understood by referring to the following detailed description. The components in the drawings are not necessarily proportional to each other. The same pictorial markings refer to corresponding similar parts.

FIG. 1 is an explosion diagram of a button battery compartment according to embodiments of the application;

FIG. 2 is a three-dimensional schematic diagram of the bottom perspective of a base according to specific embodiments of the application;

FIG. 3 shows a structural diagram of a top surface and a bottom surface of a battery cover according to specific embodiments of the application;

FIG. 4 is a locking diagram of a battery cover according to specific embodiments of the application;

FIG. 5 is an explosion diagram of a candle-like lamp according to specific embodiments of the application;

FIG. 6 is a schematic diagram of switch installation according to specific embodiments of the application;

FIG. 7 is a cross-sectional schematic diagram of the candle-like lamp after assembly according to specific embodiments of the application;

FIG. 8 is a structural diagram of three types of shell shapes according to specific embodiments of the application;

FIG. 9 is a structural diagram o the bottom assembly of the shell according to a specific embodiment of the application.

The meanings of each number in the figure:
01—base, 02—battery cover, 03—battery compartment, 04—first guiding groove, 05—second guiding groove, 06—first locking arm, 07—second locking arm, 08—locking opening, 09—elastic button, 10—force application unit, 11—first positioning notch, 12—second positioning notch, 13—columnar leg, 14—support part, 15—perforated groove, 16—clamping part, 17—clamping ring, 18—clamping column, 19—shell, 20—switch, 21—lamp bead, 22—first pin, 23—second pin, 24—switch window, 25—sliding base, 26—connection opening, 27—connection part, 28—battery, 29—handle, 30—sliding part, 31—flange, 32—clamping column, 33—lamp bead holder, 34—lamp bead cover, 35—positioning part, 36—fixed groove.

### DETAILED DESCRIPTION OF THE DISCLOSURE

In the following detailed description, according to the attached drawings, the attached drawings form part of the detailed description and are shown by illustrative specific embodiments in which the application can be practiced. For this, it uses directional terms refer to the orientation of the described graph, such as “top”, “bottom”, “left”, “right”, “up”, “down”, etc. Because the embodiments may be positioned in a number of different orientations, the directional terms are used for the purposes of illustration and are not intended to be restrictive. It should be understood that other embodiments may be utilized or logical changes may be made without departing from the scope of the application. Therefore, the following detailed description shall not be used for limitation, and the scope of the application is limited by the attached claims.

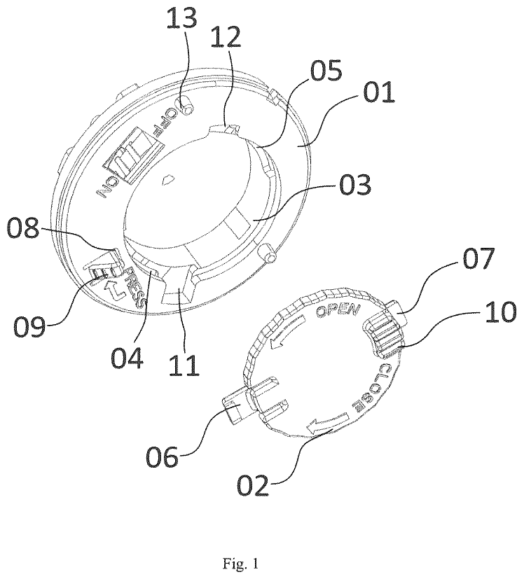

According to the first aspect of the present application, a button battery compartment assembly is proposed. FIG. 1 shows an explosion schematic diagram of the button battery compartment assembly according to the embodiment of the present application. As shown in FIG. 1, the button battery compartment assembly comprises a base 01 and a battery cover 02. The base 01 has a cylindrical battery compartment 03 that protrudes upwards. The side wall of the battery compartment 03 is provided with a first guiding groove 04 and a second guiding groove 05 extending along the same circular direction (the circular direction from the unlocking position to the locking position). The top edge of the battery cover 02 is provided with a first locking arm 06 and a second locking arm 07 extending radially. The base 01 is provided with a locking opening 08 corresponding to the locking position of the first guiding groove 04, and an elastic button 09 is provided inside the locking groove 08. There is a force application unit 10 for pushing the battery cover 02 to rotate on the bottom surface of the battery cover 02 corresponding to the position of the second locking arm 07. The force application unit 10 is located on the side of the bottom surface away from the locking opening 08. Moreover, the virtual connection line between the force application unit 10 and the locking opening 08 passes through the radial center of the battery cover 02. The bottom surface of the base 01 is provided with positioning notches at the unlocking positions of the first guiding groove 04 and the second guiding groove 05. The positioning notches comprise the first positioning notch 11 and the second positioning notch 12 corresponding to the first guiding groove 04 and the second guiding groove 05 respectively. The first locking arm 06 and the second locking arm 07 slide into the first guiding groove 04 and the second guiding groove 05 from the first positioning notch 11 and the second positioning notch 12 respectively, and the end of the first locking arm 06 is clipped into the locking opening 08.

Specifically, when the battery 28 is placed in the battery compartment 03, the first locking arm 06 and the second locking arm 07 of the battery cover 02 respectively slide from the positions of the first positioning notch 11 and the second positioning notch 12 to the locking positions of the first guiding groove 04 and the second guiding groove 05, thereby causing the end of the first locking arm 06 to be clipped into the locking opening 08 to form a secondary locking. When it is necessary to unlock the battery cover 02, the user needs to press the elastic button 09 with one hand to release the first locking arm 06 from the locking opening 08, and needs to push the force application unit 10 in the unlocking direction with the other hand to drive the battery cover 02 to rotate in the unlocking direction at the same time, achieving the function of unlocking the battery cover 02 with the cooperation of both hands. Combined with the secondary locking assembly, it can effectively prevent the safety hazards caused by children accidentally opening the battery cover 02.

Specifically, the bottom surface of the base 01 in the FIG. 1 is provided with at least two columnar legs 13 protruding outwards from the base 01. The terminal surfaces of the columnar legs 13 and the vertex of the elastic buttons 09 lie in a common virtual plane. The base 01 is the main portion of supporting the candle-like lamp, whose bottom needs to contact with the placed plane for a long time. During the process of moving the candle-like lamp, it may cause wear on some important parts located at the bottom of the base 01 (for example the battery cover 02). In this embodiment, the columnar legs 13 are provided with two, and three-point connection formed by the ends of the two columnar legs 13 and the vertex of the elastic button 09 form a triangular assembly, providing stable support for the base 01 and preventing its bottom surface from completely touching the placed plane.

Furthermore, the inner surface of the locking opening close to the base 01 contact with one side of the elastic button 09, and the elastic button 09 forms an inverted inclined triangular protrusion downwards. The inclined surface of the elastic button 09 is located on the side away from the first guiding groove 04 and extends downwards towards the edge of the base 01. Both the inclined surface of the elastic button 09 and the bottom surface of the force application unit 10 are provided with several raised anti-slip patterns to increase the friction between the user's hands and the elastic button 09 and the force application unit 10. The elastic button 09 also has a cantilever assembly similar to that of the first locking arm 06, which is more convenient for the user to press it to cause elastic deformation. Then it can press against the end of the first locking arm 06 and push it out of the locking opening 08, thus disconnecting the two. The inclined protrusion assembly of the elastic button 09 is more suitable for the operation habit of users pressing the elastic button 09 from the outside of the base 01 with their fingers.

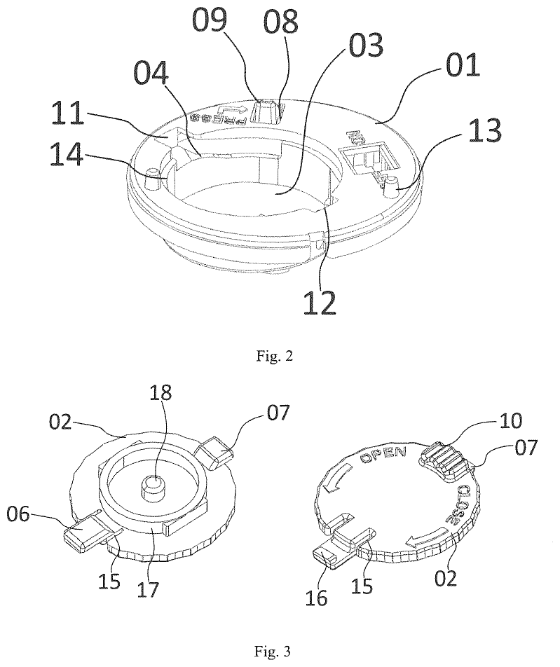

FIG. 2 shows a three-dimensional schematic diagram of the bottom perspective of a base according to specific embodiments of the application. As shown in FIG. 1-2, the first guiding groove 04 and the second guiding groove 05 are symmetrically distributed with the axis of the battery compartment 03 as the symmetry axis. From the perspective of the bottom surface of the base 01, both the first guiding groove 04 and the second guiding groove 05 extend clockwise (in a circular direction from the unlocking position to the locking position), or they can extend counterclockwise. To conform to the conventional rotary unlocking habit, a clockwise extension is adopted in this embodiment. Therefore, the first locking arm 06 and the second locking arm 07 of the battery cover 02 can respectively perform clockwise locking and counterclockwise unlocking actions along the first guiding groove 04 and the second guiding groove 05. Specifically, the first positioning notch 11 is provided precisely to face the second positioning notch 12, making the sliding strokes of the first locking arm 06 and the second locking arm 07 the same. And the first guiding groove 04 and the second guiding groove 05 gradually approach the inner top surface of the battery compartment 03 along the circumferential direction from the unlocking position to the locking position, so that both the first guiding groove 04 and the second guiding groove 05 have a stepped undulating assembly. During the locking process, the first locking arm 06 and the second locking arm 07 will be squeezed and deformed, thereby having a certain squeezing anti-disconnection effect. When the first locking arm 06 moves to the locking opening 08, it will lose the squeezing force of the first guiding groove 04, and thus can naturally spring up and get stuck in the locking opening 08, achieving a secondary locking.

In some embodiments, the upper inner side of battery compartment 03 shrinks toward the axial center to form a support part 14, (FIG. 2 is a bottom view of the base 01, the support part 14 is located at the lower part in the figure.), and the support part 14 is positioned within the circumferential area other than the first guide groove 04 and the second guide groove 05. Specifically, there is a reserved distance between the tabletop of the support part 14 and the bottom surface of the base 01, and this distance is compatible with the thickness of the battery cover 02. When the battery cover 02 rotates and locks onto the battery compartment 03, the top surface of the battery cover 02 will fit closely with the tabletop of the support part 14 and limit the distance between the top surface of the battery cover 02 and the inner top surface of the battery compartment 03, ensuring that the battery 28 in the battery compartment 03 will not be overly compressed.

FIG. 3 shows a structural diagram of a top surface and a bottom surface of a battery cover according to specific embodiments of the application. As shown in FIGS. 1-3, the left side of the figure is a schematic diagram of the top surface assembly of the battery cover 02, and the right side is a schematic diagram of the bottom surface assembly of the battery cover 02. The battery cover 02 has perforated grooves 15 on both sides of the first locking arm 06. The perforated grooves 15 create a certain gap between the two sides of the first locking arm 06 and the battery cover 02. Moreover, only one end of the first locking arm 06 is connected to the battery cover 02 to form a cantilever assembly, thereby enabling the first locking arm 06 to have a certain elastic deformation capacity. The bottom surface of the end of the first locking arm 06 protrudes downwards to form a clamping part 16, and the thickness of the clamping part 16 gradually decreases along the extension direction of the first guiding groove 04. In this embodiment, the right part of the top of the clamping part 16 is a plane, and the left part is an inclined plane. The size of the clamping part 16 makes it similar to a right-angle protrusion of an inclined plane, which makes it easier for the first locking arm 06 to slide along the first guiding groove 04 to the locking position. Moreover, due to the elastic force, the first locking arm 06 will naturally spring up, and the clamping part 16 will simultaneously clamp into the locking opening 08. During the process of the clamping part 16 inserting into the locking opening 08, it generates a mechanical clicking sound, which indicates to the user that it has been locked in place.

In some embodiments, the first locking arm 06 and the second locking arm 07 are located in a same radial direction of the battery cover 02, enabling the battery cover 02 to be more evenly stressed during installation, the extension direction of the first locking arm 06 and the second locking arm 07 are opposite, the length of the first locking arm 06 is greater than that of the second locking arm 07, and the size of the first positioning notch 11 is larger than that of the second positioning notch 12. The length difference between the first locking arm 06 and the second locking arm 07 corresponds to the size difference between the first positioning notch 11 and the second positioning notch 12, forming an installation assembly having a guiding function, which can prevent a misalignment problem caused by the mismatch between the locking arms and the guiding grooves during the installation process for users.

In some embodiments, the top surface of the battery cover 02 is provided with a raised clamping component, the clamping component comprises a clamping ring 17 and a clamping column 18 located at the center of the clamping ring 17, the clamping ring 17 takes the center of the top surface of the battery cover 02 as its center. While the battery cover 02 and the battery compartment 03 are locked, the clamping ring 17 and the clamping column 18 can provide stable support for the bottom surface of the battery 28, and firmly press the battery 28 against the battery compartment 03 in coordination with the assembly where the first guiding groove 04 and the second guiding groove 05 gradually approach the top surface inside the battery compartment 03, preventing the battery 28 from shifting or having poor contact due to shaking or vibration.

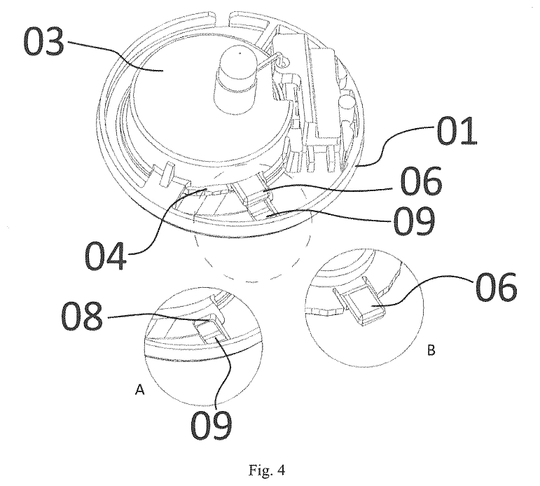

FIG. 4 shows a locking diagram of a battery cover according to specific embodiments of the application. As shown in FIG. 1-4, when the battery cover 02 is locked in place, the first locking arm 06 and the second locking arm 07 are respectively located at the locking positions of the first guiding groove 04 and the second guiding groove 05, and the clamping part 16 at the end of the first locking arm 06 slides into the locking opening 08 from the first guiding groove 04 for locking. When it is necessary to unlock, it needs to operate the elastic button 09 to push the clamping part 16 out of the locking opening 08 first, and needs to push the force application unit 10 simultaneously to drive the battery cover 02 to rotate in the unlocking direction. If the force application unit 10 is not operated simultaneously and the elastic button 09 is not released, the clamping part 16 will rebound along with the first locking arm 06 and re-enter the locking opening 08, maintaining in a locked state.

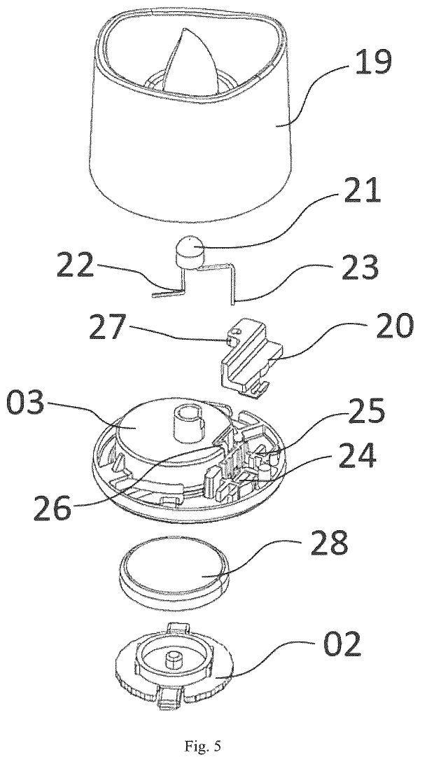

According to the second aspect of the present application, it proposes a candle-like lamp, comprising the button battery compartment assembly as described in any one of the above items. FIG. 5 shows an explosion diagram of a candle-like lamp according to specific embodiments of the application. As shown in FIGS. 1-5, the candle-like lamp also comprises a shell 19, a switch 20, a battery 28 and a lamp bead 21. The battery 28 is placed in the battery compartment 03. The shell 19 is sleeved over the base 01 from top to bottom. The lamp bead 21 has a first pin 22 and a second pin 23. The first pin 22 is vertically passed through the top of the battery compartment 03 and bent to fit closely with the inner top surface of the battery compartment 03. The base 01 is provided with a switch window 24 for the bottom of the switch 20 to pass through. The top surface of the switch window 24 protrudes to form a sliding base 25 that slides in coordination with the middle of the switch 20. The side of the battery compartment 03 close to the sliding base 25 is provided with a connection opening 26. The top of the switch 20 bends towards the connection opening 26 to form a connection part 27. The second pin 23 passes vertically through the connection part 27 and enters the battery compartment 03. The connection part 27 drives the second pin 23 to contact with or separate from the side of the battery 28.

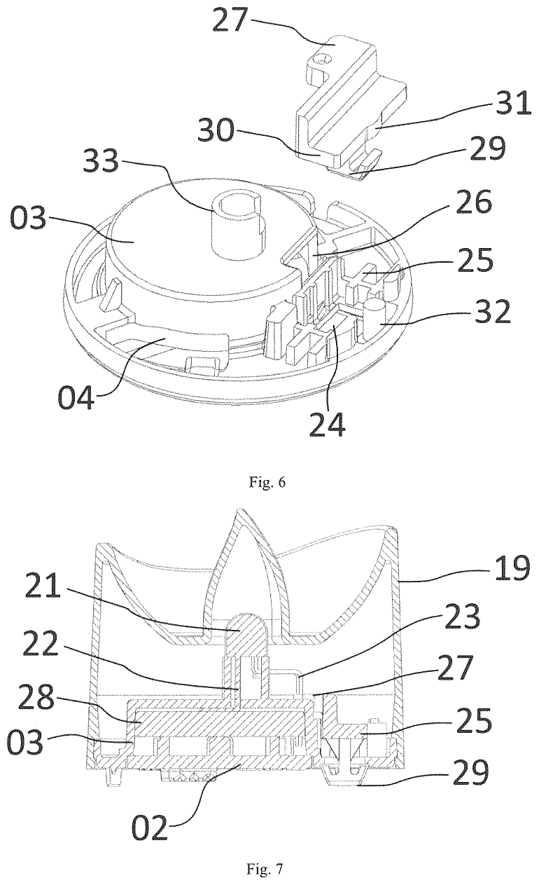

FIG. 6 shows a schematic diagram of switch installation according to specific embodiments of the application. FIG. 7 shows a cross-sectional schematic diagram of the candle-like lamp after assembly according to specific embodiments of the application. As shown in FIGS. 1-7, the middle portion of the switch 20 is provided with a sliding part 30. A handle 29 extends from the bottom surface of the sliding part 30, and the connection part 27 bends from the top of the sliding part 30 towards the connection opening 26. Specifically, the sliding part 30 is slidably mounted on the sliding base 25, and the handle 29 extends downwards from the switch window 24 to the outside of the base 01. When the sliding part 30 slides on the sliding base 25, the flange 31 will slide along with the sliding part 30 and repeatedly contact with/separate from the clamping column 32. During the adhesion/separation process, it generates a mechanical clicking sound similar to that of an electrical switch 20, which can simulate the clicking effect of a real electrical switch 20.

Specifically, the connection part 27 is provided with a through hole that fits the size of the second pin 23. After passing through this through hole, the second pin 23 enters the battery compartment 03 from the connection opening 26. When the switch 20 slides, the connection part 27 drives the second pin 23 to move in the tangential direction of the battery 28. When the second pin 23 is at the tangential point, the battery 28 is connected to the positive and negative terminals of the lamp bead 21, and the lamp bead 21 lights up. When the second pin 23 moves away from the tangential point, the two are disconnected and the lamp bead 21 goes out.

Furthermore, the inner top surface of the battery compartment 03 is also provided with a lamp bead holder 33 for placing the lamp bead 21. Moreover, within the range of the lamp bead holder 33, the top of the battery compartment 03 is provided with a through hole for the first pin 22 to pass through. After passing through this through hole, the first pin 22 adheres to the inner top surface of the battery compartment 03 and is connected to the top surface of the battery 28.

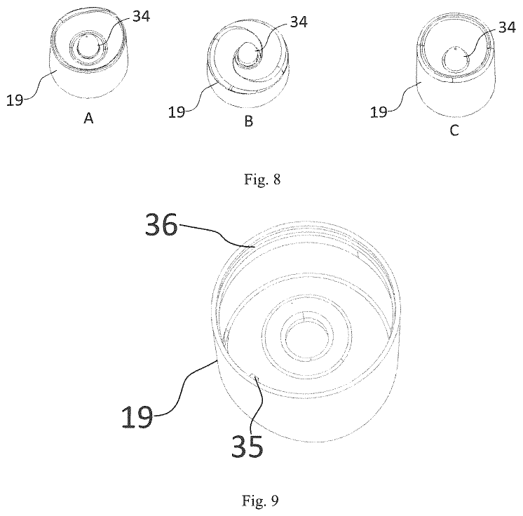

FIG. 8 shows a structural diagram of three types of shell shapes according to specific embodiments of the application. As shown in FIGS. 1-8, the shells 19 shown by A and C in the figure is designed based on the real shape of candles. The difference between the two lies in the height of the shell 19 (C is higher than A), which is often used in prayer scenario for example. The height of the shell 19 shown by B is the lowest among the three shapes, and B has added a Mobius pattern on the top of the shell 19. Compared with the conventional shape of candles, it is better-designed and more suitable for entertainment activity scenarios.

Furthermore, the top of the shell 19 is provided with a flame-shaped lamp bead cover 34, when the shell 19 is sleeved over the base 01, the light bead cover 34 encloses the light bead 21, making the light emitting from the lamp bead 21 shape is more similar to the real candle flame.

FIG. 9 shows a structural diagram of the bottom assembly of the shell according to a specific embodiment of the application. As shown in FIGS. 1-9, the inner edge of the bottom of the shell 19 is provided with an inwardly protruding positioning part 35 and a ring-shaped fixed groove 36. The outer edge of the base 01 is provided with a notch corresponding to the positioning part 35. During the installation of the shell 19, it achieves an accurate positioning through the cooperation between the positioning part 35 and the notch, and then the edge of the base 01 is clamped by the fixed groove 36, ensuring a more stable and accurate fit between the base 01 and the housing 19.

The button battery assembly and the candle-like lamp proposed by the application effectively solve the problems in the existing technology, such as unreliable battery compartment locking, wrong to open by children easily, the insufficient stability of circuit connection. In the assembly of the button battery compartment, the base 01 and the battery cover 02 form a sliding and rotating connection through the first guiding groove 04 and the second guiding groove 05 in coordination with the first locking arm 06 and the second locking arm 07. The arrangement of the locking opening 08 of the first guiding groove 04 at the locking position and the elastic button 09 constitute a secondary locking mechanism. It is necessary to operate the elastic button 09 with both hands and push the force application unit 10 to unlock, which significantly improves the effect of preventing accidental opening. The cantilever elastic assembly formed by perforated grooves 15 on both sides of the first locking arm 06 is fitted with the clamping part 16 to bounce into the locking opening 08 naturally during locking. The locking arms and positioning notches with corresponding sizes form an installation assembly having guidance ability to avoid misalignment and ensure the reliability of locking. The inner support part 14 of the battery compartment 03 works in conjunction with the clamping ring 17 and clamping column 18 on the top surface of the battery cover 02 to evenly press against the battery 28 when locking, preventing shaking, displacement and poor contact.

Obviously, those skilled in the art can make various modifications and changes to the embodiments of the present application without deviating from the spirit and scope of the present application. In this way, if these modifications and changes fall within the scope of the claims of the present application and their equivalent forms, the present application is also intended to cover these modifications and changes. The term “comprises” does not exclude the existence of other components or steps not listed in the claims. The simple fact that certain measures are recorded in different dependent claims does not indicate that the combination of these measures cannot be used for profit-making. Any drawing marks in the claims shall not be regarded as limiting the scope.

1. A button battery compartment assembly comprising a base and a battery cover, wherein the base is provided with a battery compartment for accommodating a battery, the battery compartment is provided with a guiding groove, the battery cover is configured to be switched between a locking position and an unlocking position through the guiding groove, and a portion of the battery compartment other than the guiding groove is provided with an elastic button for unlocking the battery cover in a way of the elastic button being pressed while the battery cover is being driven rotatably.

2. The button battery compartment assembly according to claim 1, wherein the base is provided with a locking opening in a position corresponding to the elastic button, an edge of the battery cover is provided with a locking arm, and an end of the locking arm is clipped into the locking opening at the locking position.

3. The button battery compartment assembly according to claim 2, wherein a bottom surface of the battery cover is also provided with a force application unit for driving rotation of the battery cover, and the force application unit is located on a side of the bottom surface away from the locking opening.

4. The button battery compartment assembly according to claim 3, wherein battery cover comprises two locking arms composed of a first locking arm and a second locking arm symmetrically provided on both sides of the battery cover.

5. The button battery compartment assembly according to claim 4, wherein the first locking arm and the second locking arm are configured to respectively slide from the unlocking position to the locking position, so as to make the end of the first locking arm to be clipped into the locking opening to lock the battery cover; a direction of elastic deformation of the elastic button generated by being pressed is orthogonal to a rotation direction of the force application unit generated by being driven.

6. The button battery compartment assembly according to claim 5, wherein the battery cover is provided with perforated grooves on both sides of the first locking arm, and an end of the first locking arm protrudes to form a clamping part configured to fit with the locking opening, and a thickness of the clamping part gradually decreases along an extension direction of the guiding groove.

7. The button battery compartment assembly according to claim 5, wherein an inner surface of one side of the locking opening is connected to one end of the elastic button, and the elastic button forms an inclined triangular protrusion outside the locking opening, an inclined surface of the elastic button extends downwards towards an edge of the base.

8. The button battery compartment assembly according to claim 4, wherein the battery compartment is provided with two guiding grooves composed of a first guiding groove and a second guiding groove corresponding to the first locking arm and the second locking arm respectively, the guiding grooves extend circumferentially from the unlocking position to the locking position and gradually approach an inner top surface of the battery compartment, and the locking opening is located at the locking position of the first guiding groove.

9. The button battery compartment assembly according to claim 1, wherein a bottom surface of the base has at least two columnar legs protruding outwards from the base, and terminal surfaces of the columnar legs and a vertex of the elastic button lie in a common virtual plane.

10. The button battery compartment assembly according to claim 1, wherein a top surface of the battery cover is provided with a raised clamping component, the clamping component comprises a clamping ring and a clamping column located at the center of the clamping ring, the clamping ring is centered on a center of the top surface of the battery cover.

11. A candle-like lamp, comprising a button battery compartment assembly according to claim 1, further comprising a shell, a switch and a lamp bead, wherein the shell is sleeved over the base, the lamp bead has a first pin and a second pin, and the first pin passes through a top of the battery compartment and is connected with the battery, the base is provided with a switch window on one side of the battery compartment, and the switch is slidably mounted above the switch window, one side of the battery compartment close to the switch window is provided with a connection opening, the first pin passes through a top of the switch and enters the connection opening, the switch drives the second pin to connect with or separate from one side of the battery.

12. The candle-like lamp according to claim 11, wherein the base is provided with a locking opening in a position corresponding to the elastic button, an edge of the battery cover is provided with a locking arm, and an end of the locking arm is clipped into the locking opening at the locking position.

13. The candle-like lamp according to claim 12, wherein a bottom surface of the battery cover is also provided with a force application unit for driving rotation of the battery cover, and the force application unit is located on a side of the bottom surface away from the locking opening.

14. The candle-like lamp according to claim 13, wherein the battery cover comprise two locking arms composed of a first locking arm and a second locking arm symmetrically provided on both sides of the battery cover.

15. The candle-like lamp according to claim 14, wherein the first locking arm and the second locking arm are configured to respectively slide from the unlocking position to the locking position, so as to make the end of the first locking arm to be clipped into the locking opening to lock the battery cover; a direction of elastic deformation of the elastic button generated by being pressed is orthogonal to a rotation direction of the force application unit generated by being driven.

16. The candle-like lamp according to claim 15, wherein the battery cover is provided with perforated grooves on both sides of the first locking arm, and an end of the first locking arm protrudes to form a clamping part configured to fit with the locking opening, and a thickness of the clamping part gradually decreases along an extension direction of the guiding groove.

17. The candle-like lamp according to claim 15, wherein an inner surface of one side of the locking opening is connected to one end of the elastic button, and the elastic button forms an inclined triangular protrusion outside the locking opening, an inclined surface of the elastic button extends downwards towards an edge of the base.

18. The candle-like lamp according to claim 14, wherein the battery compartment is provided with two guiding grooves composed of a first guiding groove and a second guiding groove corresponding to the first locking arm and the second locking arm respectively, the guiding grooves extend circumferentially from the unlocking position to the locking position and gradually approach an inner top surface of the battery compartment, and the locking opening is located at the locking position of the first guiding groove.

19. The candle-like lamp according to claim 11, wherein a bottom surface of the base has at least two columnar legs protruding outwards from the base, and terminal surfaces of the columnar legs and a vertex of the elastic button lie in a common virtual plane.

20. The candle-like lamp according to claim 11, wherein a top surface of the battery cover is provided with a raised clamping component, the clamping component comprises a clamping ring and a clamping column located at the center of the clamping ring, the clamping ring is centered on a center of the top surface of the battery cover.
